(19) United States
(12) Patent Application Publication
(10) Pub. No.: US 2013/0111315 A1
(43) Pub. Date: May 2, 2013

(54) Geographic Visualization of Data

(71) Applicants: Meir Mendelovich, Rishon Leziyyon (IL); John (Eugene) Neystadt, Kfar-Saba (IL)

(72) Inventors: Meir Mendelovich, Rishon Leziyyon (IL); John (Eugene) Neystadt, Kfar-Saba (IL)

(73) Assignee: MICROSOFT CORPORATION, Redmond, WA (US)

(21) Appl. No.: 13/282,476

(22) Filed: Oct. 27, 2011

(51) Int. Cl. G06F 17/00

(52) U.S. Cl. 715/205; 715/211; 707/E17.018; 707/E17.044

(57) ABSTRACT

Aspects of the subject matter described herein relate to geographic visualization of data. In aspects, data is obtained from a data store. Geographical data within the data is identified. The geographical data is provided to a mapping service that returns mapping data that includes locations corresponding to the geographical data. From the mapping data, a map is drawn that shows graphical elements for tuples of the data.

### BACKGROUND

Tabular data, such as data in a spreadsheet, may include geographical information. For example, a company may list salespeople in a spreadsheet that, for each row, includes a name of the salesperson as well as an office address of where the salesperson works. The spreadsheet may also include home addresses of the salespeople in tabular form. In its tabular form, analyzing and visualizing this data is difficult.

The subject matter claimed herein is not limited to embodiments that solve any disadvantages or that operate only in environments such as those described above. Rather, this background is only provided to illustrate one exemplary technology area where some embodiments described herein may be practiced.

### SUMMARY

Briefly, aspects of the subject matter described herein relate to geographic visualization of data. In aspects, data is obtained from a data store. Geographical data within the data is identified. The geographical data is provided to a mapping service that returns mapping data that includes locations corresponding to the geographical data. From the mapping data, a map is drawn that shows graphical elements for tuples of the data.

### BRIEF DESCRIPTION OF THE DRAWINGS

FIG. 1 is a block diagram representing an exemplary general-purpose computing environment into which aspects of the subject matter described herein may be incorporated;

FIG. 2 is a block diagram that represents an exemplary environment in which aspects of the subject matter described herein may be implemented;

FIG. 3 is a diagram that represents exemplary data in tabular form in accordance with aspects of the subject matter described herein;

FIG. 4 is a diagram that represents data that has been indicated as containing geographical data in accordance with aspects of the subject matter described herein;

FIG. 5 is a diagram that represents tabular data and a map corresponding to the tabular data in accordance with aspects of the subject matter described herein; and

FIGS. 6-7 are flow diagrams that generally represent exemplary actions that may occur in accordance with aspects of the subject matter described herein.

### DETAILED DESCRIPTION

### Definitions

As used herein, the term “includes” and its variants are to be read as open-ended terms that mean “includes, but is not limited to.” The term “or” is to be read as “and/or” unless the context clearly dictates otherwise. The term “based on” is to be read as “based at least in part on.” The terms “one embodiment” and “an embodiment” are to be read as “at least one embodiment.” The term “another embodiment” is to be read as “at least one other embodiment.”

As used herein, terms such as “a,” “an,” and “the” are inclusive of one or more of the indicated item or action. In particular, in the claims a reference to an item generally means at least one such item is present and a reference to an action means at least one instance of the action is performed.

Sometimes herein the terms “first”, “second”, “third” and so forth may be used. Without additional context, the use of these terms in the claims is not intended to imply an ordering but is rather used for identification purposes. For example, the phrase “first version” and “second version” does not necessarily mean that the first version is the very first version or was created before the second version or even that the first version is requested or operated on before the second versions. Rather, these phrases are used to identify different versions.

Headings are for convenience only; information on a given topic may be found outside the section whose heading indicates that topic.

Other definitions, explicit and implicit, may be included below.

### Exemplary Operating Environment

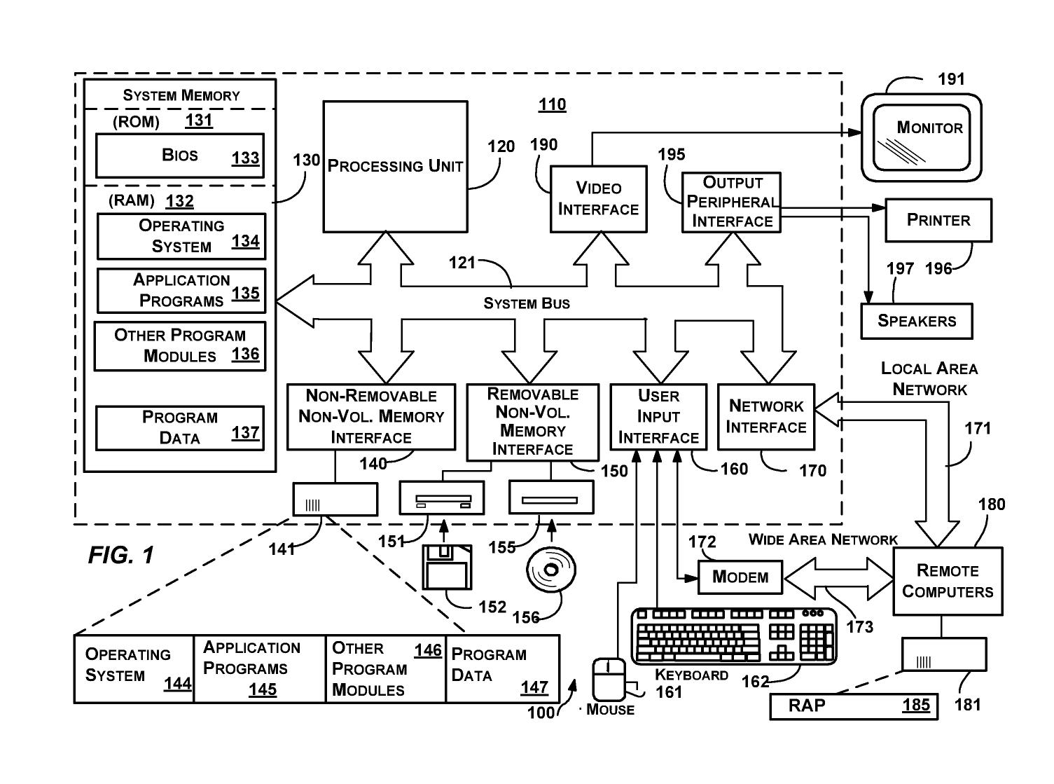

FIG. 1 illustrates an example of a suitable computing system environment 100 on which aspects of the subject matter described herein may be implemented. The computing system environment 100 is only one example of a suitable computing environment and is not intended to suggest any limitation as to the scope of use or functionality of aspects of the subject matter described herein. Neither should the computing environment 100 be interpreted as having any dependency or requirement relating to any one or combination of components illustrated in the exemplary operating environment 100.

Aspects of the subject matter described herein are operational with numerous other general purpose or special purpose computing system environments or configurations. Examples of well-known computing systems, environments, or configurations that may be suitable for use with aspects of the subject matter described herein comprise personal computers, server computers, hand-held or laptop devices, multiprocessor systems, microcontroller-based systems, set-top boxes, programmable consumer electronics, network PCs, minicomputers, mainframe computers, personal digital assistants (PDAs), gaming devices, printers, appliances including set-top, media center, or other appliances, automobile-embedded or attached computing devices, other mobile devices, distributed computing environments that include any of the above systems or devices, and the like.

Aspects of the subject matter described herein may be described in the general context of computer-executable instructions, such as program modules, being executed by a computer. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing aspects of the subject matter described herein includes a general-purpose computing device in the form of a computer 110. A computer may include any electronic device that is capable of executing an instruction. Components of the computer 110 may include a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus also known as Mezzanine bus, Peripheral Component Interconnect Extended (PCI-X) bus, Advanced Graphics Port (AGP), and PCI express (PCIe).

The computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media.

Computer storage media includes both volatile and nonvolatile, removable and non-removable media implemented in any method or technology for storage of information such as computer-readable instructions, data structures, program modules, or other data. Computer storage media includes RAM, ROM, EEPROM, solid state storage, flash memory or other memory technology, CD-ROM, digital versatile discs (DVDs) or other optical disk storage, magnetic cassettes, magnetic tape, magnetic disk storage or other magnetic storage devices, or any other medium which can be used to store the desired information and which can be accessed by the computer 110.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct wired connection, and wireless media such as acoustic, RF, infrared and other wireless media. Combinations of any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disc drive 155 that reads from or writes to a removable, nonvolatile optical disc 156 such as a CD ROM or other optical media. Other removable/non-removable, volatile/nonvolatile computer storage media that can be used in the exemplary operating environment include magnetic tape cassettes, flash memory cards, digital versatile discs, other optical discs, digital video tape, solid state RAM, solid state ROM, and the like. The hard disk drive 141 may be connected to the system bus 121 through the interface 140, and magnetic disk drive 151 and optical disc drive 155 may be connected to the system bus 121 by an interface for removable non-volatile memory such as the interface 150.

The drives and their associated computer storage media, discussed above and illustrated in FIG. 1, provide storage of computer-readable instructions, data structures, program modules, and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies.

A user may enter commands and information into the computer 110 through input devices such as a keyboard 162 and pointing device 161, commonly referred to as a mouse, trackball, or touch pad. Other input devices (not shown) may include a microphone, joystick, game pad, satellite dish, scanner, a touch-sensitive screen, a writing tablet, or the like. These and other input devices are often connected to the processing unit 120 through a user input interface 160 that is coupled to the system bus, but may be connected by other interface and bus structures, such as a parallel port, game port or a universal serial bus (USB).

A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets, and the Internet.

When used in a LAN networking environment, the computer 110 is connected to the LAN 171 through a network interface or adapter 170. When used in a WAN networking environment, the computer 110 may include a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

### Visualization of Data

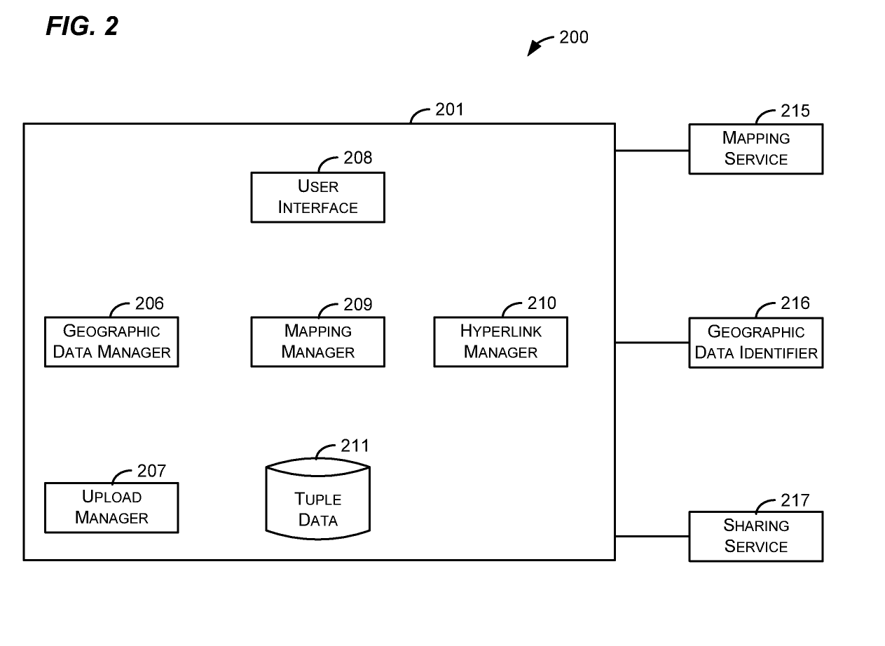

As mentioned previously, analyzing and visualizing data that is in tabular form is difficult. FIG. 2 is a block diagram that represents an exemplary environment in which aspects of the subject matter described herein may be implemented. The environment 200 may include visualization components 201, a mapping service 215, a geographic data identifier 216, a sharing service 217, and other components (not shown). The visualization components 201 may include a geographic data manager 206, an upload manager 207, a user interface 208, a mapping manager 209, a hyperlink manager 210, a store 211 that stores tuples, and other components (not shown).

As used herein, the term component is to be read to include hardware such as all or a portion of a device, a collection of one or more software modules or portions thereof, some combination of one or more software modules or portions thereof and one or more devices or portions thereof, and the like.

A component may include or be represented by code. Code includes instructions that indicate actions a computer is to take. Code may also include information other than actions the computer is to take such as data, resources, variables, definitions, relationships, associations, and the like.

The components illustrated in FIG. 2 are exemplary and are not meant to be all-inclusive of components that may be needed or included. In other embodiments, the components described in conjunction with FIG. 2 may be included in other components (shown or not shown) or placed in subcomponents without departing from the spirit or scope of aspects of the subject matter described herein. In some embodiments, the entities and/or functions described in conjunction with FIG. 2 may be distributed across multiple devices.

The components illustrated in FIG. 2 may be implemented using one or more computing devices. Such devices may include, for example, personal computers, server computers, hand-held or laptop devices, multiprocessor systems, microcontroller-based systems, set-top boxes, programmable consumer electronics, network PCs, minicomputers, mainframe computers, cell phones, personal digital assistants (PDAs), gaming devices, printers, appliances including set-top, media center, or other appliances, automobile-embedded or attached computing devices, other mobile devices, distributed computing environments that include any of the above systems or devices, and the like.

An exemplary device that may be configured to implement one or more of the components of FIG. 2 comprises the computer 110 of FIG. 1.

The geographic data manager 206 may obtain geographical data from the data store 211. Geographical data may include one or more of: coordinates, longitude, latitude, altitude, city, state, county, country, zip code, and the like. In addition to or instead of the geographical data above, geographical data may include a formal or informal name of a location. For example, geographical data may include a name such as “space needle,” “tri-state area,” “the golden gate,” other formal or informal names, and the like. The geographic data manger 206 may identify the geographical data within the data store 211 automatically, semi-automatically, or manually.

The data store 211 may include any storage media capable of storing data. The data store 211 may include volatile memory (e.g., a cache), non-volatile memory (e.g., a persistent storage), storage media described in conjunction with FIG. 1, and the like. The term data is to be read broadly to include anything that may be represented by one or more computer storage elements. Logically, data may be represented as a series of 1's and 0's in volatile or non-volatile memory. In computers that have a non-binary storage medium, data may be represented according to the capabilities of the storage medium. Data may be organized into different types of data structures including simple data types such as numbers, letters, and the like, hierarchical, linked, or other related data types, data structures that include multiple other data structures or simple data types, and the like. Some examples of data include information, program code, program state, program data, other data, and the like.

The data store 211 provides access to tuples of data. As used herein, a tuple is a collection of data elements. Each data element may store data. The term tuple data refers to the data of one or more tuples. Access as used herein may include reading data, writing data, deleting data, updating data, a combination including two or more of the above, and the like.

The data store 211 may be implemented as a database. As used herein a database may comprise a relational database, object-oriented database, hierarchical database, network database, other types of database, some combination or extension of the above, and the like. Data stored in a database may be organized in tables, records, objects, other data structures, and the like. The data corresponding to the data store 211 may be stored in dedicated database files, dedicated hard drive partitions, HTML files, XML files, spreadsheets, flat files, document files, configuration files, other files, and the like.

Data in a database may be accessed via a database management system (DBMS). A DBMS may comprise one or more programs that control organization, storage, management, and retrieval of data of a database. A DBMS may receive requests to access data in a database and may perform the operations needed to provide this access. Even if the data store 211 is implemented with a database, when the data is stored in certain formats (e.g., XML, HTML, spreadsheet, flat files, document files, or the like), a local program may be used to view the data without contacting a remote DBMS.

In describing aspects of the subject matter described herein, for simplicity, terminology associated with relational databases is sometimes used herein. Although relational database terminology is sometimes used herein, the teachings herein may also be applied to other types of databases including those that have been mentioned previously.

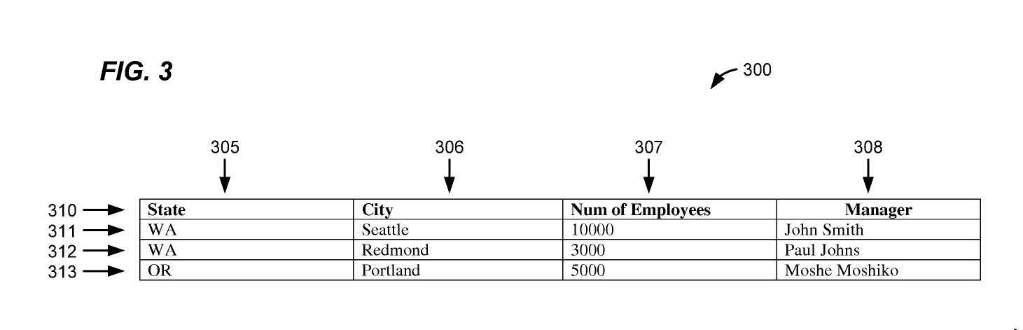

In one example, data stored in the data store 211 is organized in the form of a table as illustrated in FIG. 3. FIG. 3 is a diagram that represents exemplary data in tabular form in accordance with aspects of the subject matter described herein. As illustrated, the table 300 includes four columns 305-308 and four rows 310-313. The number of columns and rows is exemplary only. In other examples, there may be more or fewer columns and rows and the names of the columns and rows may be different.

The row 310 contains header information for each of the columns 305-308, while the rows 311-313 include row data. The columns 305 and 306 include geographical data that may be used to identify locations on a map. The rows 311-313 represent tuples of the table 300.

In another example, data stored in the data store 211 may be organized in the form of HTML files, XML files, flat files, document files, configuration files, other data structures, or the like. In other words, data stored in the data store 211 is not required to be represented or expressed as a table. For example, data in the data store 211 may include data in the form of:

Store #1:
Seattle
John Torrel
10,000

Store #2:
Portland
Mike Chang
20,000

. . .

Based on the teachings herein, those skilled in the art will recognize that the data above could be represented in XML or some other format without departing from the spirit or scope of aspects of the subject matter described herein.

Returning to FIG. 2, the geographic data manager 206 may identify geographical data within the tuple data by receiving input from a user through the user interface 208, by sending one or more tuples to a geographic data identifier 216 and receiving therefrom an indication of the geographic data, by a combination of the techniques above, or the like.

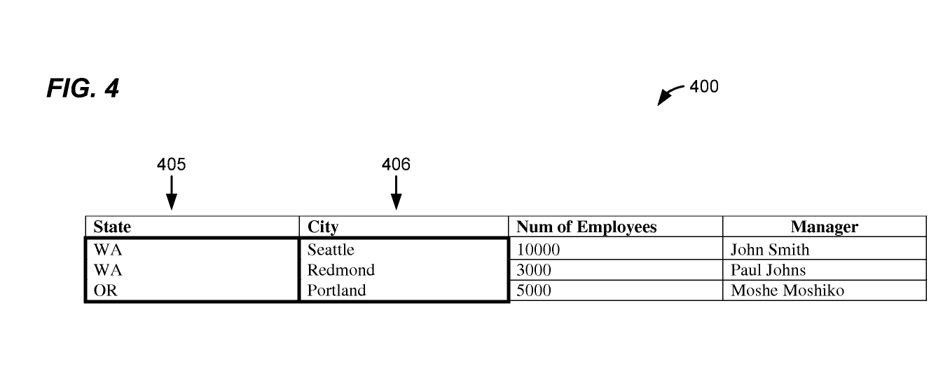

FIG. 4 is a diagram that represents data that has been indicated as containing geographical data in accordance with aspects of the subject matter described herein. As illustrated, data within the columns 405 and 406 of the table 400 have been indicated as containing geographical data. This may be done, for example, via the user interface 208 of FIG. 2.

Returning to FIG. 2, the mapping manager 209 may be operable to obtain mapping data that represents a map. The mapping manager 209 may obtain the mapping data by sending the geographical data of the tuple data to a mapping service (e.g., such as the mapping service 215). In response, the mapping service may return mapping data that represents a map together with identifiers that identify different locations on the map corresponding to the geographical data provided to the mapping service.

The identifiers returned with the mapping data identify locations associated with geographical data of the tuples. These identifiers may be represented graphically in a variety of ways. For example, an identifier may be represented via the use of a graphical element that looks like a pushpin, thumbtack, line, arrow, circle, polygon, two dimensional or three-dimensional surface, picture, icon, a simplified representation of the underlying data (e.g., a graphical element that looks like a person, building, activity, or the like), other graphical elements, a combination of two or more of the above, and the like.

The user interface 208 is a component that allows a user to interact with the other visualization components 201. For example, a user may use the user interface 208 to specify that one or more other data elements of a tuple be used to influence the characteristics of the graphical representations of an identifier.

As some examples, one or more data elements of a tuple may be used to specify size, color, fill, background image, other characteristics, and the like of a graphical representation of an identifier. Size may be effective, for example, to show graphically how many employees are at a site, the volume of sales or other transactions that occur at a site, the number of referrals that come from a site, or other numerical data about a tuple. For example, referring to FIG. 3, a user may select the column 307 and indicate that the data in this column is to be used for sizing the graphical representations of the location identifiers on a map that correspond to the rows of the table 300.

It is possible for some reason (e.g., incomplete data, corrupted data, missing data, or the like) that some of the tuples may not include geographical data. In this case, the mapping data may include an identifier that identifies a default (e.g., previously selected or indicated) location to which such tuples are mapped.

As another example, the user interface 208 may allow a user to indicate where the geographical data of the tuple data is located. For example, referring to FIG. 3, a user may use a user interface to indicate that the geographical data is included in columns 305-306. This example is also illustrated in FIG. 4.

The mapping manager 209 may insert the mapping data into a data structure (e.g., a spreadsheet or database file) that includes the tuple data. In this form, the mapping data may be usable by a program (e.g., a spreadsheet, database, or other program) to draw a map in a graphical interface (e.g., the user interface 208) when displaying the tuple data. In this form, the program may allow a user to scroll through the rows of the tuple data and may highlight (e.g., as the user is scrolling) the location associated with each row on the map.

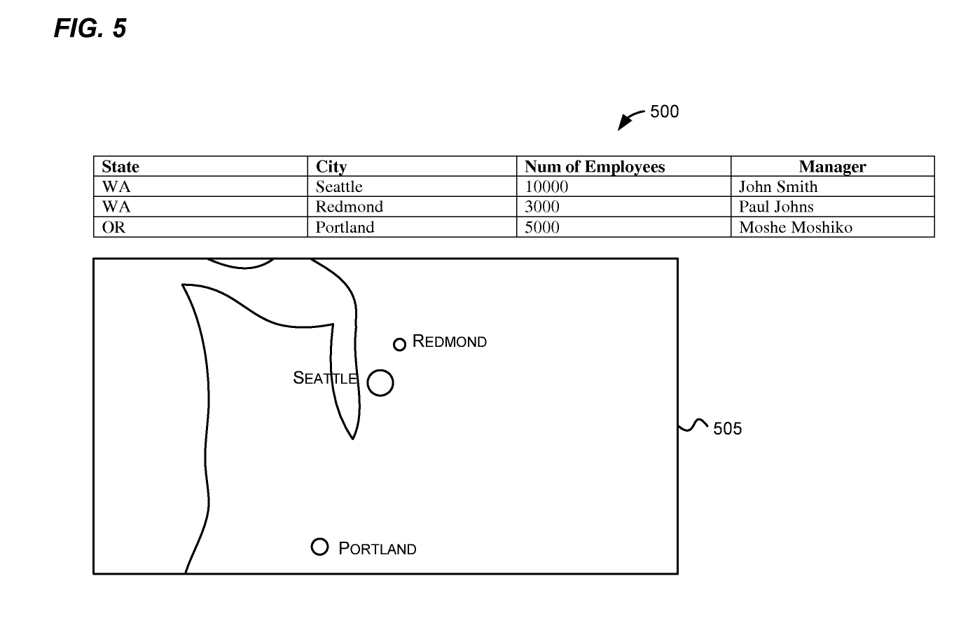

FIG. 5 is a diagram that represents tabular data and a map corresponding to the tabular data in accordance with aspects of the subject matter described herein. As illustrated in FIG. 5, a map 505 is shown that represents the table 500. The circle identifiers of the map 505 are sized according to the number of employees at each location. This map may be imported into a spreadsheet or other program that includes the table 500. Selecting a row of the table 500 may cause a circle identifier of the map 505 to be displayed. Selecting a circle identifier may cause a row of the table 500 to be highlighted, may cause a text bubble or other graphical element to appear that includes data from other data elements of the tuple associated with the circle identifier, or may cause other actions to occur.

Returning to FIG. 2, the upload manager 207 may be operable to save tuple data and a map (or a link thereto) to an online service such as the sharing service 217. Users may then use the sharing service 217 to view the tuple data and/or the map that was previously saved to the sharing service 217. In one embodiment, these other users may also be able to update the tuple data and to cause that a new map be generated based thereon.

The hyperlink manager 210 comprises a component that may insert hyperlink data into a data structure that includes the tuple data. For example, if the tuple data is represented as a table, the hyperlink manager 210 may create or use a hyperlink column in the table and may then insert hyperlink data into the hyperlink column for each row of the table. The hyperlink data for a tuple references a location on a map. Selecting a hyperlink that corresponds to the hyperlink data may cause an identifier of the map to be highlighted.

The mapping service 215 is component that receives geographical data and, in response, returns a map and identifiers that identify different locations on the map corresponding to the geographical data. As used herein, a service may include one or more processes, threads, components, libraries, or the like that perform a designated task. A service may be implemented in hardware, software, or a combination of hardware and software. A service may be distributed over multiple devices or may be implemented on a single device.

The geographic data identifier 216 is a component that receives one or more tuples and uses the information therefrom to identify geographic data in the tuples. In one implementation, geographical data may be identified via user input into the user interface. In another implementation where the tuples are represented as a table, geographical data may be indicated by metadata about the columns of the table. In either of these implementations, the geographical data identifier 216 may be omitted.

The sharing service 217 allows tuple data and a map or a link thereto to be uploaded to the sharing service 217. After the tuple data and map (or link thereto) are uploaded, the sharing service 217 may provide this data for viewing the tuple data and map.

Although the mapping service 215, the geographic data identifier 216, and the sharing service 217 are illustrated as being remote to the visualization components 201, in other embodiments, one or more of these components may be local to the visualization components 201. Being local to the visualization components 201 means that one or more of these components may be hosted on an apparatus that hosts one or more of the visualization components.

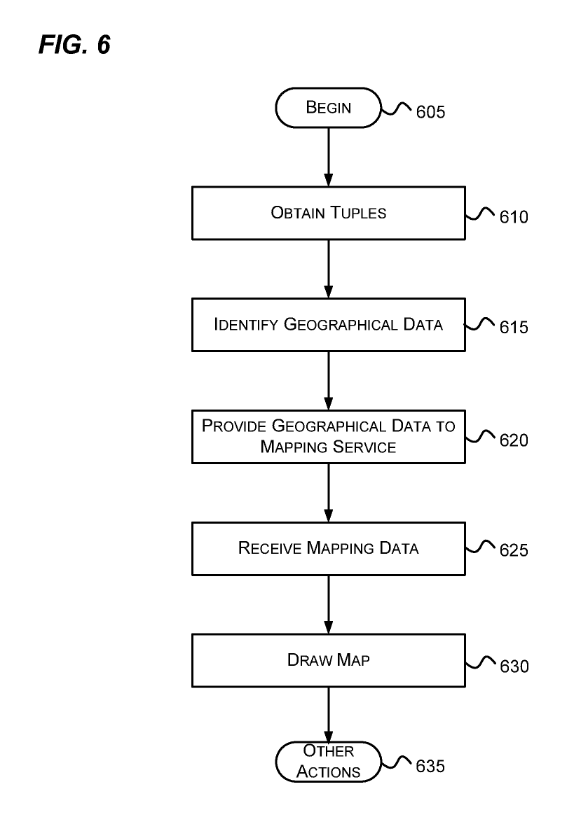

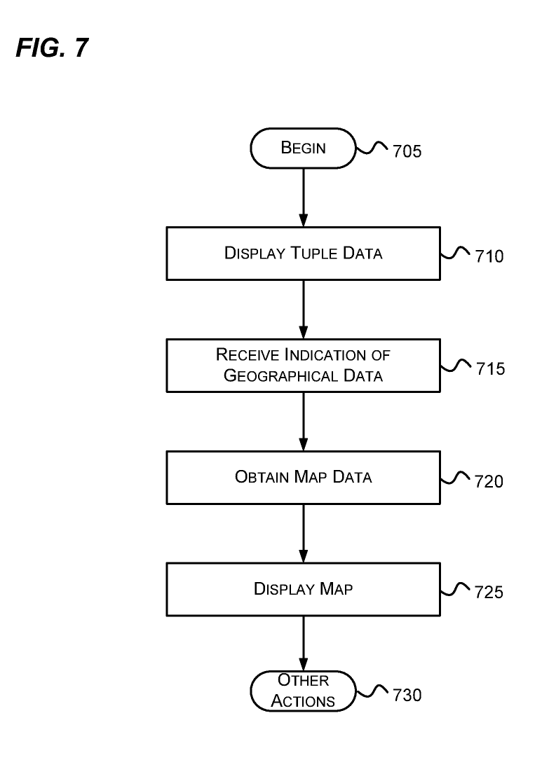

FIGS. 6-7 are flow diagrams that generally represent exemplary actions that may occur in accordance with aspects of the subject matter described herein. For simplicity of explanation, the methodology described in conjunction with FIGS. 6-7 is depicted and described as a series of acts. It is to be understood and appreciated that aspects of the subject matter described herein are not limited by the acts illustrated and/or by the order of acts. In one embodiment, the acts occur in an order as described below. In other embodiments, however, the acts may occur in parallel, in another order, and/or with other acts not presented and described herein. Furthermore, not all illustrated acts may be required to implement the methodology in accordance with aspects of the subject matter described herein. In addition, those skilled in the art will understand and appreciate that the methodology could alternatively be represented as a series of interrelated states via a state diagram or as events

Turning to FIG. 6, at block 605, the actions begin. At block 610, a plurality of tuples is obtained. The tuples include geographical data. One or more data elements within the tuples may correspond to the geographical data. For example, referring to FIGS. 2-3, tuples corresponding to the table 300 may be obtained from the data store 211, the user interface 208, or elsewhere.

At block 615, geographical data within the tuples is identified. For example, referring to FIGS. 2-3, the columns 305 and 307 are identified as having geographical data. These columns may be identified by obtaining input from the user interface 208, by sending tuples to the geographic data identifier 216 and receiving therefrom an indication of the geographical data, or in another manner previously indicated.

At block 620, the geographical data is provided to a mapping service. For example, referring to FIG. 2, the geographical data may be provided by the mapping manager 209 to the mapping service 215.

At block 625, mapping data is received. For example, referring to FIG. 2, mapping data is received from the mapping service 215.

At block 630, a map is drawn. The map includes a graphical element for each of the tuples that include a portion of the geographical data. The graphical element located on the map in a place corresponding to the geographical data. If a tuple does not include geographical data, a graphical element may be omitted or a graphical element may be displayed at a default location as indicated previously. For example, referring to FIGS. 2 and 5, the map 505 may be drawn on the user interface 208.

At block 635, other actions, if any, may be performed. For example, if the tuples are represented in table form, a new column may be created for the tabular data. For each row of the table, a link may be created in the new column that identifies a location on the map corresponding to the portion of the geographical data. Creating a link may include placing hyperlink data within the new column. This hyperlink data is represented by a hyperlink element of a graphical interface. The hyperlink element is operable to cause the location on the map to be displayed when selected within the graphical interface.

As another example or other actions, display data may be received via a graphical interface. The display data may indicate a column of the table that is to be used for a characteristic of the graphical element when drawing the graphical element for each tuple represented in the map. For example, referring to FIG. 5, a user may indicate that the number of employees column is to be used in a size characteristic of the circles displayed on the map 505.

As another example of other actions, the mapping data may be inserted into a data structure that includes the tuple data. For example, referring to FIG. 5, the mapping data corresponding to the map 505 may be inserted into a spreadsheet that includes the table 500.

As another example of other actions, the tuple data and mapping data or link thereto may be saved to an online service to make the tuple data and the map available for sharing. For example, referring to FIG. 2. The upload manager 207 may upload the tuple data from the data store 211 and the mapping data or a link thereto to the sharing service 217. Afterwards, others may view/update the tuple data.

The examples of other actions indicated above are not intended to be all-inclusive or exhaustive of other actions that may occur. Based on the teachings herein, those skilled in the art may recognize other actions that may occur without departing from the spirit or scope of aspects of the subject matter described herein.

Turning to FIG. 7, at block 705, the actions begin. At block 710, tuple data is displayed via a graphical interface. For example, referring to FIGS. 2 and 3, the tuples are displayed in the form of the table 308 illustrated in FIG. 3 via the user interface 208 of FIG. 2.

At block 715, an indication is received via the graphical interface of geographical data contained in the tuple data. For example, referring to FIGS. 2 and 4, geographical data manger 206 receives the indication that columns 405 and 406 include geographical data.

At block 720, map data is obtained. The map data includes a plurality of location identifiers. The location identifiers correspond to the geographical data of the tuple data. For example, referring to FIG. 2, the mapping manager 209 obtains mapping data from the mapping service 215 by sending the geographical data previously obtained to the mapping service 215. In response, the mapping service 215 provides the mapping data and location identifiers that correspond to the geographical data of the tabular data.

At block 725, a map is displayed that shows graphical elements for the location identifiers. For example, referring to FIGS. 2 and 5, the user interface 208 is used to display a map 505 that has circles representing the location identifiers returned by the mapping service 215. A characteristic (e.g., the size of the circles) is indicated by other data (e.g., the number of employees) indicated in the table 500.

At block 730, other actions, if any, may be performed.

As can be seen from the foregoing detailed description, aspects have been described related to geographic visualization of data. While aspects of the subject matter described herein are susceptible to various modifications and alternative constructions, certain illustrated embodiments thereof are shown in the drawings and have been described above in detail. It should be understood, however, that there is no intention to limit aspects of the claimed subject matter to the specific forms disclosed, but on the contrary, the intention is to cover all modifications, alternative constructions, and equivalents falling within the spirit and scope of various aspects of the subject matter described herein.

What is claimed is:

1. A method implemented at least in part by a computer, the method comprising:
obtaining a plurality of tuples, the tuples including geographical data;
identifying the geographical data within the tuples;
providing the geographical data to a mapping service;
receiving mapping data from the mapping service; and
from the mapping data, drawing a map that has a graphical element for each of the tuples that includes a portion of the geographical data, the graphical element located on the map in a place corresponding to the geographical data.

2. The method of claim 1, wherein obtaining a plurality of tuples comprises obtaining the tuples from tabular data that includes the tuples, the tabular data representing a table that includes rows that correspond to the tuples.

3. The method of claim 2, further comprising creating a new column for the table and, for each row that includes a portion of the geographical data, creating a link in the new column that identifies a location on the map corresponding to the portion of the geographical data.

4. The method of claim 3, wherein creating a link in the new column comprises placing hyperlink data within the new column, the hyperlink data represented by a hyperlink element of a graphical interface, the hyperlink element operable to cause the location on the map to be displayed when selected within the graphical interface.

5. The method of claim 2, further comprising receiving, via a graphical interface, display data that indicates a column of the table that is to be used for a characteristic of the graphical element when drawing the graphical element for each tuple represented in the map.

6. The method of claim 5, wherein receiving, via a graphical interface, display data that indicates a column comprises receiving a column identifier of a column that includes data indicating one or more of size, color, fill, and background image to be used in drawing the graphical element for each tuple represented in the map.

7. The method of claim 2, further comprising inserting the mapping data into a data structure that includes the tabular data.

8. The method of claim 7, wherein inserting the mapping data into a data structure that includes the tabular data comprises inserting the mapping data into a spreadsheet.

9. The method of claim 1, further comprising saving the tuples and a link to the map to an online service to make the tuples and the map available for sharing.

10. The method of claim 1, wherein obtaining a plurality of tuples comprises obtaining a set of tuples, where each tuple of the set of tuples includes one or more data elements corresponding to the geographical data.

11. In a computing environment, a system, comprising:
a data store operable to provide access to a plurality of tuples, the tuples including geographical data;
a geographic data manager operable to obtain the geographical data from the data store; and
a mapping manager operable to obtain mapping data that represents a map, the mapping data including identifiers that, for each of the tuples, identifies a location associated with the tuple, the location derived from the geographical data.

12. The system of claim 11, wherein the geographical data manager is further operable to identify the geographical data by sending one or more of the tuples to a geographic data identifier.

13. The system of claim 11, further comprising a graphical interface and wherein the geographical data manager is further operable to identify the geographical data by receiving input via the graphical interface.

14. The system of claim 11, further comprising a hyperlink manager operable to insert hyperlink data into a data structure that includes the tuples, the hyperlink data corresponding to a hyperlink that references a location on the map.

15. The system of claim 11, further comprising an upload manager operable to save the tuples and a link to the map to an online service for sharing the tuples and the map.

16. The system of claim 11, wherein the mapping manager is operable to obtain mapping data that represents a map by sending the geographical data to a mapping service, the mapping service sending mapping data in response thereto.

17. The system of claim 11, wherein the mapping manager is further operable to insert the mapping data into a data structure that includes the tuples, the mapping data usable to draw the map in a graphical interface.

18. A computer storage medium having computer-executable instructions, which when executed perform actions, comprising:
displaying tuple data via a graphical interface;
receiving, via the graphical interface, an indication of geographical data contained in the tuple data;
obtaining map data that includes a plurality of location identifiers, the location identifiers corresponding to the geographical data of the tuple data; and
displaying a map that shows graphical elements for the location identifiers.

19. The computer storage medium of claim 18, wherein displaying a map that shows graphical elements for the location identifiers comprising drawing a characteristic of the graphical elements as indicated by other data in the tuple data.

20. The computer storage medium of claim 18, wherein obtaining map data comprises providing the geographical data to a mapping service and in response thereto receiving the map data.
